(19) United States
(12) Patent Application Publication
(10) Pub. No.: US 2024/0288651 A1
(43) Pub. Date: Aug. 29, 2024

(54) CROSS CONNECT RACK WITH CABLE MANAGEMENT PORTIONS CONFIGURED TO PERMIT A USER TO SELECT AND/OR CHANGE THE CONFIGURATION OF THE RACK WITHOUT DISCONNECTING CABLES

(71) Applicant: PPC BROADBAND, INC., East Syracuse, NY (US)

(72) Inventors: Afzal V. ABDULSALAM, Ernakulam (KL) (IN); Jerin RAJ, Coimbatore (TN) (IN); Syed Ali Hussaini AZHAR, Riyadh (SA); Ceegan Alex FRANCIS, Alappuzha (KL) (IN); Icy Kollielil VARGHESE, Tripunithura (KL) (IN)

(73) Assignee: PPC BROADBAND, INC., East Syracuse, NY (US)

(21) Appl. No.: 18/586,153

(22) Filed: Feb. 23, 2024

Related U.S. Application Data
(60) Provisional application No. 63/463,589, filed on May 3, 2023.

(30) Foreign Application Priority Data
Feb. 24, 2023 (IN) 202321012606

(51) Int. Cl. G02B 6/44

(52) U.S. Cl. CPC G02B 6/44524; G02B 6/44526; G02B 6/4455

(57) ABSTRACT

A cable panel rack includes: a center frame portion; and distribution cable management and bottom cable portions configured to be attached to the center frame portion. The center frame portion is configured to be attached at a first portion of the bottom cable portion when the distribution cable management portion is attached to a first side of the center frame portion, and the center frame portion is configured to be attached at a second portion of the bottom cable portion when the distribution cable management portion is attached to a second side of the center frame portion, so as to permit a user to select and/or change a configuration of the cable panel rack at an installation location without disconnecting cables from the cable panels in the center rack frame portion.

### CROSS-REFERENCE TO RELATED APPLICATION

This application claims the benefit of India Provisional Patent Application No. 202321012606, filed Feb. 24, 2023, and U.S. Provisional Application No. 63/463,589 filed May 3, 2023, which are currently pending, the disclosures of which are hereby incorporated by reference herein in their entireties.

### BACKGROUND

The present invention relates generally to racks. More particularly, the present invention relates to racks for cable panels and cable management, where the racks have parts that can be located in multiple positions to provide multiple configurations using the same parts.

Examples of conventional rack systems for splitter panels and other panels are configured as a left-hand configuration or a right-hand configuration and are not reconfigurable for the opposite hand configuration.

There is a need for a system that permits a user to select and/or changes an arrangement of cable management portions between left-hand and right-hand configurations using a small number of the same parts regardless of the configuration.

### SUMMARY

The present disclosure provides a much needed rack system that can be easily converted between a left-hand side configuration and a right-hand side configuration without needing any additional or different parts.

Embodiments provide a customized rack system with, for example, a 47 unit (47 U) height and special cable management systems. Embodiments include, for example, two variants of racks, one being 900 mm wide and one being 1050 mm wide, with both variants having the same features. In embodiments, the rack system is configured for use in a wide range of application and can be customized based on requirements of a particular application. In embodiments, the rack has four main areas: center rack frame, input cable management, distribution cable management, and bottom cable tray. Embodiments of the rack have cable management systems for input cables and output (for example, distribution) cables which can be interchanged between the right and left sides based on the particular application. This interchangeability is achieved with the same parts for a left-hand configuration and a right-hand configuration. Embodiments provide a modular and scalable platform for managing panels such as, for example, fiber optic panels, and cables such as, for example, fiber optic cables. Examples of panels installed in the rack include, but are not limited to cable splitter panels and optical distribution frame (ODF) feeder panels.

Embodiments of the rack system provide interchangeability of cable management assemblies to each side without using different parts. To change the sides of the cable management assemblies, the existing parts simply need to be re-assembled in a different configuration. This reconfigurability results in a smaller number of different parts being needed, and therefore, simplified inventory management. Embodiments allow the cable management assemblies to be switched to the opposite sides of the center rack frame with the center rack frame loaded with panels. Also, the cable management assemblies can be switched from one side to the other without disconnecting cables from the panels. Embodiments include a bottom cable tray that is configured to permit cables to be routed from one rack to an adjacent rack.

Embodiments enable the use of the same parts to form different rack combinations such as, for example, a combination of one left-hand rack and one right-hand rack, a series of racks including any number of left-hand racks and right-hand racks, back-to-back combinations of left-hand and right-hand racks, or any combination of these combinations.

Embodiments of the disclosure provide a rack with cable management that is configurable as either a left-hand rack or a right-hand rack using the same components, providing configurability at an installation location without needing additional components and thereby reducing required inventory.

A cable panel rack may be configured to be arranged as either a left-hand rack with a center rack frame portion attached at a first portion of a bottom cable portion or a right-hand rack with the center rack frame portion attached at a second portion of the bottom cable portion, so as to permit a user to select and/or change a configuration of the cable panel rack at an installation location without needing additional components and without disconnecting cables from the cable panels in the center rack frame portion.

Embodiments provide a cable panel rack including: a center rack frame portion; a distribution cable management portion configured to be attached to the center rack frame portion; an input cable portion configured to be attached to the center rack frame portion; a drop cable guiding portion configured to be attached to the distribution cable management portion; and a bottom cable portion configured to be attached to the center rack frame portion. The center rack frame portion may be structurally configured to receive a plurality of cable panels; the distribution cable management portion may be configured to be alternatively attached to a first side of the center rack frame portion and a second side of the center rack frame portion; the input cable portion may be configured to be alternatively attached to the first side of the center rack frame portion and the second side of the center rack frame portion; the drop cable guiding portion may be configured to be attached to the distribution cable management portion in either a first drop cable guiding portion position or a second drop cable guiding portion position based on a position of the distribution cable management portion; the center rack frame portion may be configured to be attached at a first portion of the bottom cable portion when the distribution cable management portion is attached to the first side of the center rack frame portion; the center rack frame portion may be configured to be attached at a second portion of the bottom cable portion when the distribution cable management portion is attached to the second side of the center rack frame portion; and the cable panel rack may be configured to be arranged as either a left-hand rack with the center rack frame portion attached at the first portion or a right-hand rack with the center rack frame portion attached at the second portion, so as to permit a user to select and/or change a configuration of the cable panel rack at an installation location without needing additional components and without disconnecting cables from the cable panels in the center rack frame portion.

In embodiments, the first side of the center rack frame portion may be opposite to the second side of the center rack frame portion.

In embodiments, the distribution cable management portion may comprise a first set of holes and a second set of holes.

In embodiments, the drop cable guiding portion may be configured to be alternatively attached to the distribution cable management portion in either the first set of holes or the second set of holes.

In embodiments, the center rack frame portion may attach to the bottom cable portion in the first position when the drop cable guiding portion is attached to the distribution cable management portion in the first set of holes.

In embodiments, the center rack frame portion may attach to the bottom cable portion in the second position when the drop cable guiding portion is attached to the distribution cable management portion in the second set of holes.

In embodiments, the cable panel rack may further comprise a cable routing portion that may be configured to be attached to the distribution cable management portion.

In embodiments, the distribution cable management portion may be configured to have the cable routing portion alternatively attached to the distribution cable management portion in a plurality of locations on the distribution cable management portion.

Embodiments provide a cable panel rack including: a center rack frame portion structurally configured to receive a plurality of cable panels; a distribution cable management portion configured to be attached to the center rack frame portion; an input cable portion configured to be attached to the center rack frame portion; and a bottom cable portion configured to be attached to the center rack frame portion. The distribution cable management portion may be configured to be alternatively attached to a first side of the center rack frame portion and a second side of the center rack frame portion; the input cable portion may be configured to be alternatively attached to the first side of the center rack frame portion and the second side of the center rack frame portion; the center rack frame portion may be configured to be attached at a first portion of the bottom cable portion when the distribution cable management portion is attached to the first side of the center rack frame portion; the center rack frame portion may be configured to be attached at a second portion of the bottom cable portion when the distribution cable management portion is attached to the second side of the center rack frame portion; and the cable panel rack may be configured to be arranged with either the center rack frame portion attached at the first portion or with the center rack frame portion attached at the second portion, so as to permit a user to select and/or change a configuration of the cable panel rack at an installation location without disconnecting cables from the cable panels in the center rack frame portion.

In embodiments, the cable panel rack may further comprise a drop cable guiding portion that may be configured to be attached to the distribution cable management portion.

In embodiments, the drop cable guiding portion may be configured to be attached to the distribution cable management portion in either a first drop cable guiding portion position or a second drop cable guiding portion position based on a position of the distribution cable management portion relative to the center rack frame portion.

In embodiments, the distribution cable management portion may comprise a first set of holes and a second set of holes.

In embodiments, the drop cable guiding portion may be configured to be alternatively attached to the distribution cable management portion in either the first set of holes or the second set of holes.

In embodiments, the first side of the center rack frame portion may be opposite to the second side of the center rack frame portion.

In embodiments, the cable panel rack may further comprise a cable routing portion that may be configured to be attached to the distribution cable management portion.

In embodiments, the distribution cable management portion may be configured to have the cable routing portion mounted to the distribution cable management portion in a plurality of locations on the distribution cable management portion.

In embodiments, the cable panel rack may be configured to be arranged with either the center rack frame portion attached at the first portion or with the center rack frame portion attached at the second portion, so as to permit a user to select and/or change a configuration of the cable panel rack at an installation location without needing additional components.

Embodiments provide a cable panel rack including: a center frame portion structurally configured to receive a plurality of cable panels; a distribution cable management portion configured to be attached to the center frame portion; and a bottom cable portion configured to be attached to the center frame portion. The distribution cable management portion may be configured to be alternatively attached to a first side of the center frame portion and a second side of the center frame portion; the center frame portion may be configured to be attached at a first portion of the bottom cable portion when the distribution cable management portion is attached to the first side of the center frame portion; the center frame portion may be configured to be attached at a second portion of the bottom cable portion when the distribution cable management portion is attached to the second side of the center frame portion; and the cable panel rack may be configured to be arranged with either the center frame portion attached at the first portion or with the center frame portion attached at the second portion, so as to permit a user to select and/or change a configuration of the cable panel rack at an installation location without disconnecting cables from the cable panels in the center rack frame portion.

In embodiments, the cable panel rack may further comprise an input cable portion that may be configured to be attached to the center frame portion.

In embodiments, the input cable portion may be configured to be alternatively attached to the first side of the center frame portion and the second side of the center frame portion.

In embodiments, the cable panel rack may further comprise a drop cable guiding portion that may be configured to be attached to the distribution cable management portion in either a first drop cable guiding portion position or a second drop cable guiding portion position based on a position of the distribution cable management portion relative to the center frame portion.

In embodiments, the distribution cable management portion may comprise a first set of holes and a second set of holes, and the drop cable guiding portion may be configured to be alternatively attached to the distribution cable management portion in either the first set of holes or the second set of holes.

In embodiments, the first side of the center frame portion may be opposite to the second side of the center frame portion.

In embodiments, the cable panel rack may further comprise a cable routing portion that may be configured to be attached to the distribution cable management portion, the distribution cable management portion may be configured to have the cable routing portion mounted to the distribution cable management portion in a plurality of locations on the distribution cable management portion.

In embodiments, the cable panel rack may be configured to be arranged with either the center frame portion attached at the first portion or with the center frame portion attached at the second portion, so as to permit a user to select and/or change a configuration of the cable panel rack at an installation location without needing additional components.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a front right perspective view of a right-hand variant of a rack in accordance with various aspects of the disclosure with cable panels in place.

FIG. 2 is a front right perspective view of a left-hand variant of the rack of FIG. 1 without cable panels.

FIG. 3 is a front left perspective view of the left-hand variant of the rack of FIG. 2.

FIG. 4 is a front view of the rack of FIG. 2.

FIG. 5 is a front view of the rack of FIG. 1 without cable panels.

FIG. 6 is a front left perspective view of the rack of FIG. 5.

FIG. 7 is a perspective view of a rack frame in accordance with various aspects of the disclosure.

FIG. 8 is a perspective view of a distribution cable management plate in accordance with various aspects of the disclosure.

FIG. 9 is a first perspective view of an input cable tray in accordance with various aspects of the disclosure.

FIG. 10 is a second perspective view of the input cable tray of FIG. 8.

FIG. 11 is a perspective view of a drop cable guiding plate in accordance with various aspects of the disclosure.

FIG. 12 is a perspective view of a bottom cable tray in accordance with various aspects of the disclosure.

FIG. 13 is a front right perspective view of a left-hand variant of an alternate rack in accordance with various aspects of the disclosure without cable panels.

FIG. 14 is a front right perspective view of a right-hand variant of the rack of FIG. 13.

FIG. 15 is a perspective view of a drop cable guiding plate in accordance with various aspects of the disclosure for use with the rack of FIGS. 13 and 14.

FIG. 16 is a perspective view of an exemplary combination rack connecting the racks of FIGS. 13 and 14 together.

FIG. 17 is a perspective view of an exemplary series of the racks of FIG. 13 connected together.

FIG. 18 is a perspective view of an exemplary back-to-back configuration of a combination of the racks of FIGS. 13 and 14.

FIG. 19 is a perspective view of a first alternate drop cable guiding plate in accordance with various aspects of the disclosure.

FIG. 20 is a perspective view of a second alternate drop cable guiding plate in accordance with various aspects of the disclosure.

FIG. 21 is a perspective view of an alternate input cable tray in accordance with various aspects of the disclosure.

FIG. 22 is a perspective view of an alternate rack frame in accordance with various aspects of the disclosure.

### DETAILED DESCRIPTION OF EMBODIMENTS

Embodiments of the disclosure provide a rack with cable management that is configurable as either a left-hand rack or a right-hand rack using the same components, providing configurability at an installation location without needing additional components and thereby reducing required inventory.

A cable panel rack may be configured to be arranged as either a left-hand rack with a center rack frame portion attached at a first portion of a bottom cable portion or a right-hand rack with the center rack frame portion attached at a second portion of the bottom cable portion, so as to permit a user to select and/or change a configuration of the cable panel rack at an installation location without needing additional components and without disconnecting cables from the cable panels in the center rack frame portion.

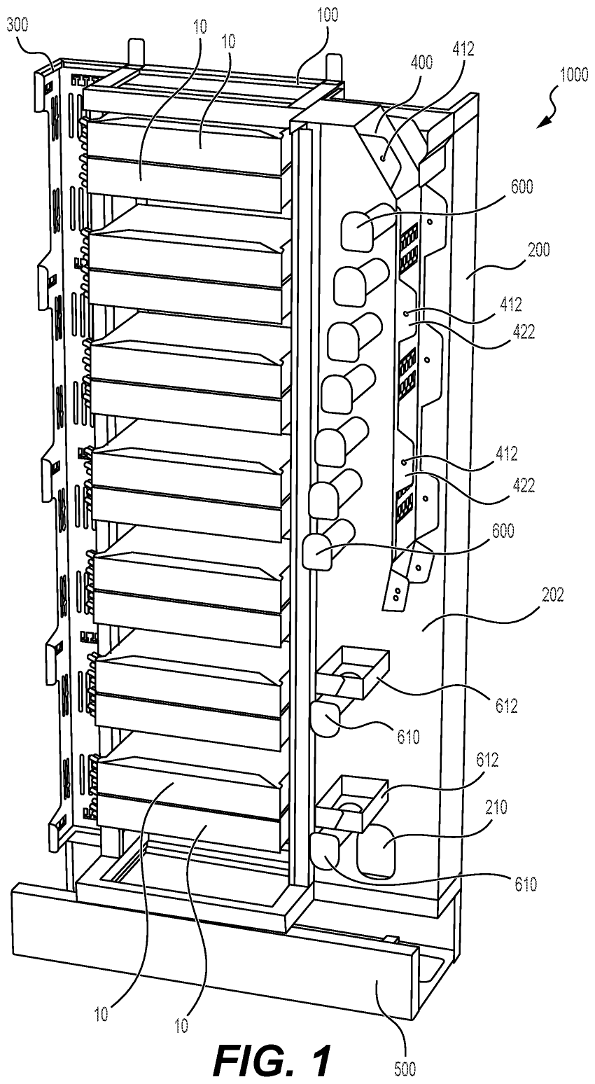

FIG. 1 shows an exemplary rack 1000 in accordance with embodiments of the disclosure. In this example, the rack 1000 is configured to receive a plurality of panels 10. In embodiments, the panels 10 include, for example, cable splitter panels and/or optical distribution frame (ODF) feeder panels.

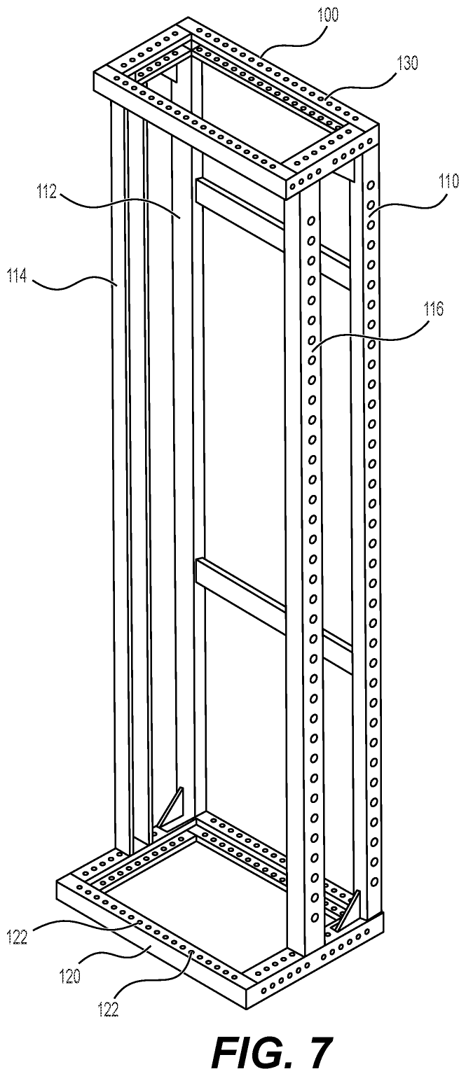

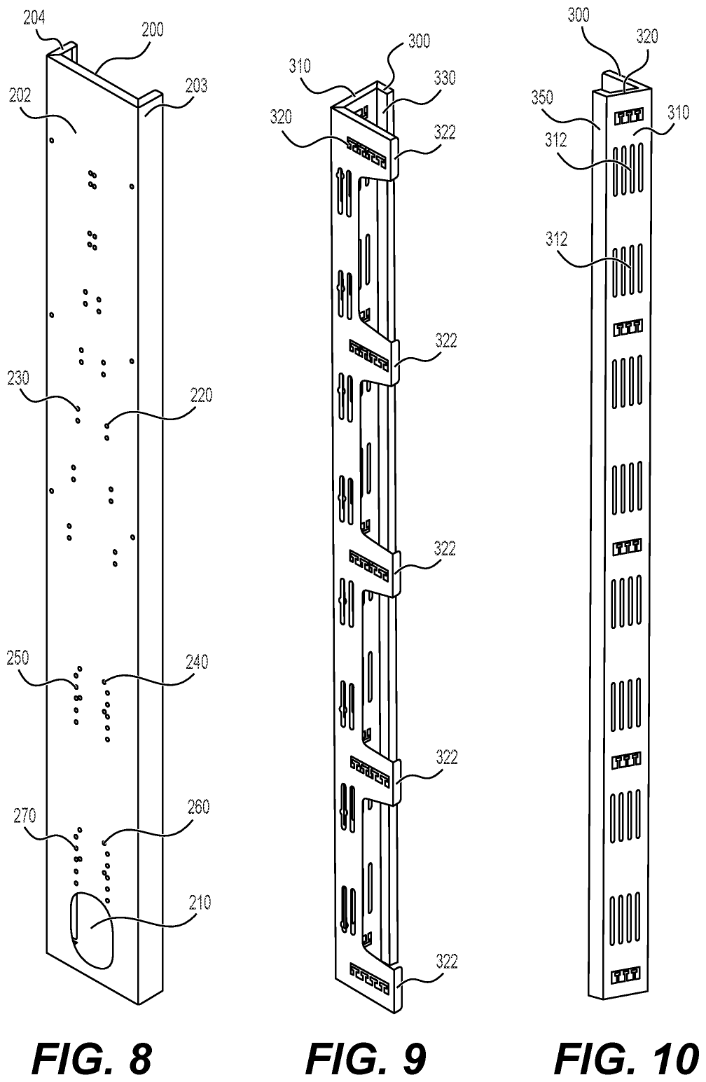

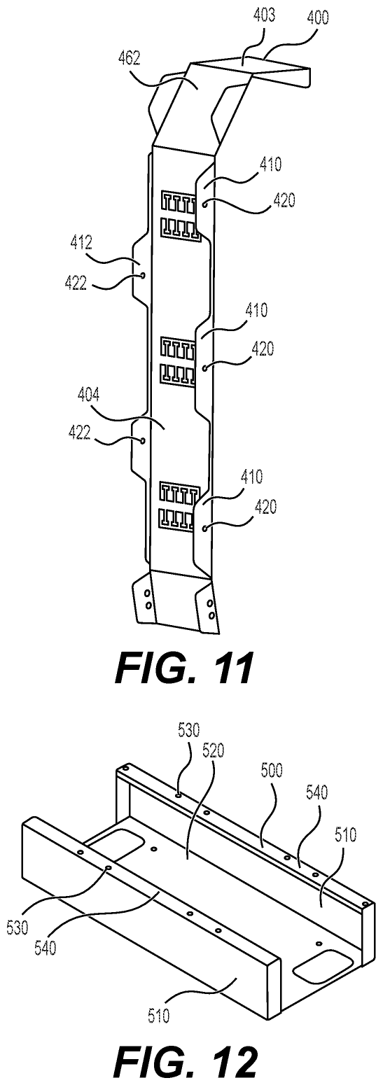

In the embodiment shown in FIG. 1, the rack 1000 is configured in a right-hand (RH) variant or configuration. The rack 1000 has a center rack frame portion, for example, a center frame portion, or a center rack frame, 100 (shown in detail in FIG. 7) to which other components are connected. The center rack frame 100 is configured to receive a plurality of the panels 10. In the RH configuration, a distribution cable management portion, for example, a distribution cable management plate, 200 (shown in detail in FIG. 8) is attached to the right side of the center rack frame 100. In the RH configuration, an input cable portion, for example, an input cable tray, 300 (shown in detail in FIGS. 9 and 10) is attached to the left side of the center rack frame 100. A drop cable guiding portion, for example, a drop cable guiding plate, 400 (shown in detail in FIG. 11) is attached to the distribution cable management plate 200. A bottom cable portion, for example, a bottom cable tray, 500 (shown in detail in FIG. 12) is positioned at the bottom of the rack 1000 and is attached to the center rack frame 100.

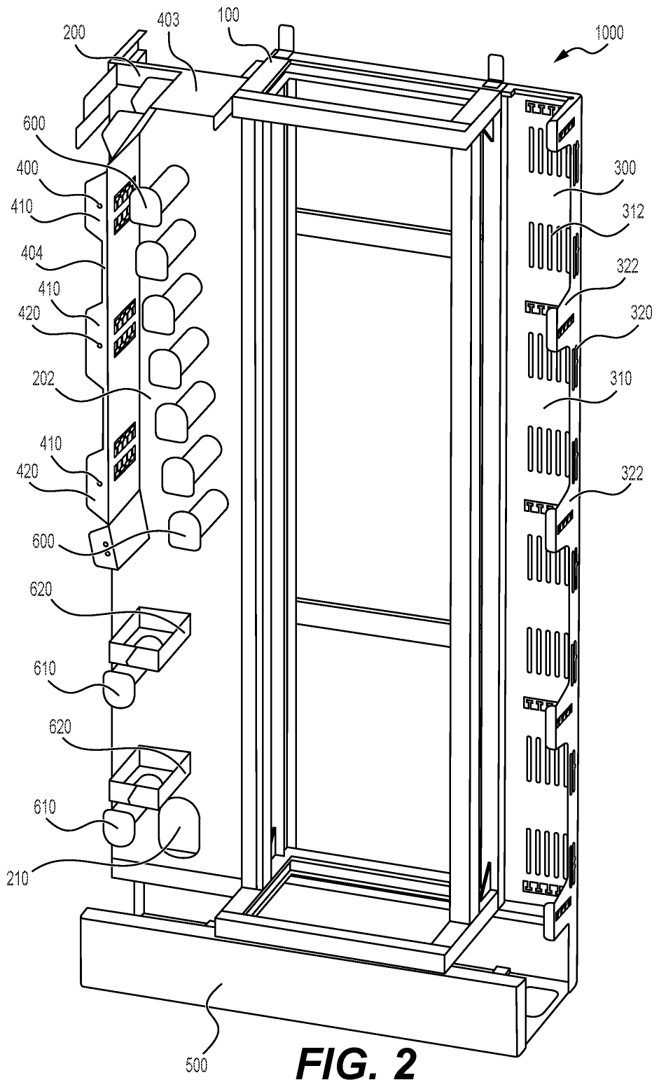

FIG. 2 shows an example of the rack 1000 configured in a left-hand (LH) variant or configuration. In FIG. 2 and subsequent FIGS., the panels 10 are omitted so that the structure of the rack 1000 can be more clearly seen. In FIG. 2, because it is assembled in the LH configuration, the distribution cable management plate 200 is attached to the left side of the center rack frame 100. In this LH configuration, the input cable tray 300 is attached to the right side of the center rack frame 100. The drop cable guiding plate 400 is attached to the distribution cable management plate 200 in a similar manner as in the RH configuration of FIG. 1, except that the opposite edge of the drop cable guiding plate 400 is attached to the distribution cable management plate 200 in the LH configuration of FIG. 2. This will be explained in more detail below. The bottom cable tray 500 is positioned at the bottom of the rack 1000 and is attached to the center rack frame 100, similarly to the RH configuration of FIG. 1.

FIG. 2 shows a plurality of cable routing portions, for example, mandrels, 600 attached to the distribution cable management plate 200. The mandrels are configured for routing and separating cables that are positioned in the distribution cable management plate 200. In this example, one of the mandrels 600 (marked A-G in this example) is provided for each panel mounting location (marked A-G in this example). This example includes two lower mandrels 610 and two shelves 620 that are configured to provide cable management. One or more of the mandrels 600, 610 are offset from others of the mandrels to allow cables to be separated from each other and, for example, follow different vertical paths.

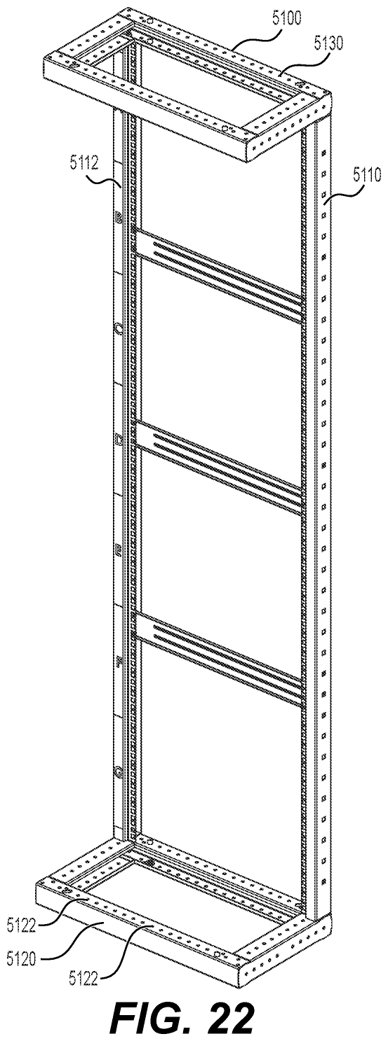

The particular components of the rack 1000 will now be discussed with reference to FIGS. 7-12. FIG. 7 shows an example of the center rack frame 100. In this example, the center rack frame 100 includes a bottom frame 120 to which four vertical frame members 110, 112, 114, 116 are attached. A top frame 130 is attached to the upper ends of the vertical frame members 110, 112, 114, 116. In this example, all of the members of the center rack frame 100 include a plurality of holes that are configured to receive fasteners that connect the center rack frame 100 to various other ones of the components of the rack 1000. For example, the bottom frame 120 includes a plurality of holes 122 that are configured to receive screws that extend through the bottom frame 120 and into holes 530 in the bottom cable tray 500 (shown in FIG. 12). FIG. 22 shows an example of an alternate center rack frame 5100. In this example, the center rack frame 5100 includes a bottom frame 5120 to which two vertical frame members 5110 and 5112 are attached. A top frame 5130 is attached to the upper ends of the vertical frame members 5110 and 5112. In this example, all of the members of the center rack frame 5100 include a plurality of holes that are configured to receive fasteners that connect the center rack frame 5100 to various other ones of the components of the rack 1000. For example, the bottom frame 5120 includes a plurality of holes 5122 that are configured to receive screws that extend through the bottom frame 5120 and into holes 530 in the bottom cable tray 500 (shown in FIG. 12).

FIG. 8 shows an example of the distribution cable management plate 200. In this example, the distribution cable management plate 200 has a main panel 202 form which a first edge 203 and a second edge 204 extend. This example includes an opening 210 that is configured to allow cables to extend through the distribution cable management plate 200 from a front side to a rear side. In this example, the distribution cable management plate 200 includes two groups of holes that are symmetrically located. A first group of the holes are configured for use when the rack 1000 is in a RH configuration. A second group of the holes are configured for use when the rack 1000 is in a LH configuration. For example, holes 220, 240, 260 are for use when the rack 1000 is in a RH configuration such as shown in FIG. 1. Holes 230, 250, 270 are for use when the rack 1000 is in a LH configuration such as shown in FIG. 2. In this example, holes 220 are configured to attach the mandrels 600 to the distribution cable management plate 200 in the RH configuration, and holes 240, 260 are configured to attach the lower mandrels 610 and the shelves 620 to the distribution cable management plate 200 in the RH configuration. In this example, holes 230 are configured to attach the mandrels 600 to the distribution cable management plate 200 in the LH configuration, and holes 250, 270 are configured to attach the lower mandrels 610 and the shelves 620 to the distribution cable management plate 200 in the LH configuration.

The configuration of the distribution cable management plate 200 shown in FIG. 8 allows the same distribution cable management plate 200 to be used in both the RH configuration and the LH configuration. This avoids having to manufacture and inventory two different distribution cable management plates. This, like several other features of the rack 1000, also allows the rack 1000 to be reconfigured between the LH configuration and the RH configuration in the field without the need for any additional parts.

The first edge 203 or the second edge 204 (depending on the LH or RH configuration) of the distribution cable management plate 200 is attached to the center rack frame 100 by, for example, one or more fasteners such as, for example, screws. In the RH configuration, the first edge 203 is attached to the center rack frame 100. In the LH configuration, the second edge 204 is attached to the center rack frame 100.

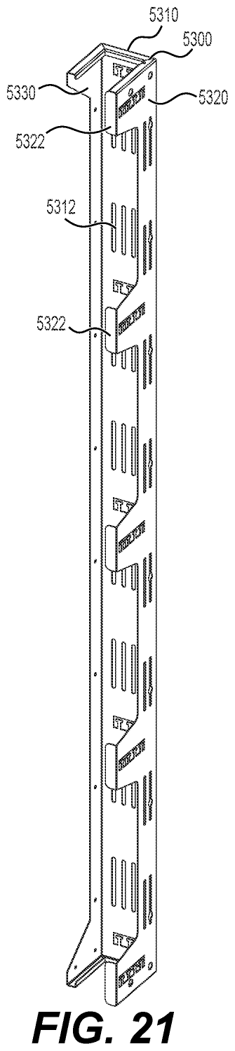

FIGS. 9 and 10 show an example of the input cable tray 300. In this example, the input cable tray 300 has a back plate 310, an extension 320 that extends (in this example) at a right angle from the back plate 310, and a plurality of tabs 322 that extend from the extension 320. The input cable tray 300 also has a flange 330 that extends (in this example) at a right angle from the back plate 310. As shown in FIGS. 9 and 10, the input cable tray 300 is symmetrical in the vertical direction. For use in the RH configuration (FIG. 1), the flange 330 is attached by, for example, screws to the left side of the center rack frame 100. For use in the LH configuration (FIG. 2), the flange 330 is attached by, for example, screws to the right side of the center rack frame 100. In this example, a plurality of slots 312 are provided in the back plate 310. The slots 312 can be used to secure cables to the back plate 310 using, for example, cable ties. FIG. 21 shows an example of an alternate input cable tray 5300. In this example, the input cable tray 5300 has a back plate 5310, an extension 5320 that extends (in this example) at a right angle from the back plate 5310, and a plurality of tabs 5322 that extend from the extension 5320. The input cable tray 5300 also has a flange 5330 that extends (in this example) at a right angle from the back plate 5310. As shown in FIG. 21, the input cable tray 5300 is symmetrical in the vertical direction. For use in the RH configuration (FIG. 1), the flange 5330 is attached by, for example, screws to the left side of the center rack frame 100, 5100. For use in the LH configuration (FIG. 2), the flange 5330 is attached by, for example, screws to the right side of the center rack frame 100, 5100. In this example, a plurality of slots 5312 are provided in the back plate 5310. The slots 5312 can be used to secure cables to the back plate 5310 using, for example, cable ties.

The configuration of the input cable tray 300 shown in FIGS. 9 and 10 allows the same input cable tray 300 to be used in both the RH configuration and the LH configuration. This avoids having to manufacture and inventory two different input cable trays. This, like several other features of the rack 1000, also allows the rack 1000 to be reconfigured between the LH configuration and the RH configuration in the field without the need for any additional parts.

Whereas the distribution cable management plate 200 stays in the same orientation (the opening 210 is at the bottom) when used in either the RH or LH configuration, the input cable tray 300 is used in the orientation shown in FIGS. 9 and 10 or it is flipped upside down depending on whether the RH of LH configuration is used.

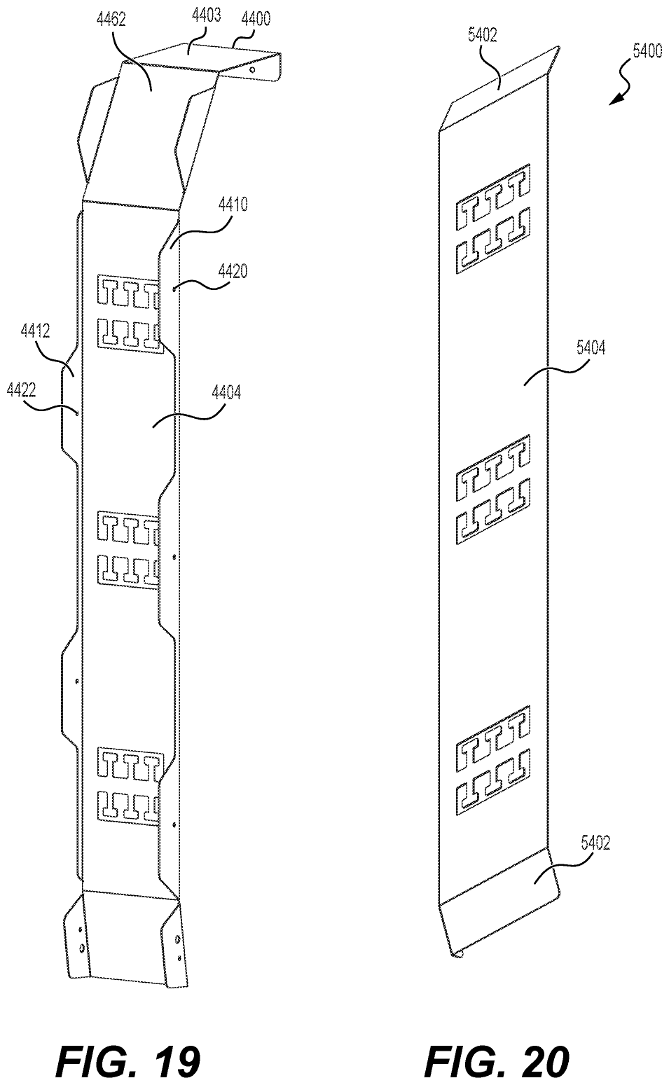

FIG. 11 shows an example of the drop cable guiding plate 400. In this example, the drop cable guiding plate 400 has a main section 404, an angled section 462 that extends from the main section 404, and a top section 403 that extends from the angled section 462, that are configured to guide cables positioned in the distribution cable management plate 200. Drop cable guiding plate 400 can be provided with additional sections configured to guide cables positioned in the distribution cable management plate 200. In this example, the drop cable guiding plate 400 has a plurality of flanges 410 extending from one side and a plurality of flanges 412 extending from an opposite side. The flanges 410 (by way of holes 420) are configured to be used to attach the drop cable guiding plate 400 to the distribution cable management plate 200 in the RH configuration (FIG. 1), and the flanges 412 (by way of holes 422) are configured to be used to attach the drop cable guiding plate 400 to the distribution cable management plate 200 in the LH configuration (FIG. 2). FIG. 19 shows an example of the drop cable guiding plate 4400. In this example, the drop cable guiding plate 4400 has a main section 4404, an angled section 4462 that extends from the main section 4404, and a top section 4403 that extends from the angled section 4462, that are configured to guide cables positioned in the distribution cable management plate 200. Drop cable guiding plate 4400 can be provided with additional sections configured to guide cables positioned in the distribution cable management plate 200. In this example, the drop cable guiding plate 4400 has a plurality of flanges 4410 extending from one side and a plurality of flanges 4412 extending from an opposite side. The flanges 4410 (by way of holes 4420) are configured to be used to attach the drop cable guiding plate 4400 to the distribution cable management plate 200 in the RH configuration (FIG. 1), and the flanges 4412 (by way of holes 422) are configured to be used to attach the drop cable guiding plate 4400 to the distribution cable management plate 200 in the LH configuration (FIG. 2).

The configuration of the drop cable guiding plate 400 shown in FIG. 11 allows the same drop cable guiding plate 400 to be used in both the RH configuration and the LH configuration. This avoids having to manufacture and inventory two different drop cable guiding plates. This, like several other features of the rack 1000, also allows the rack 1000 to be reconfigured between the LH configuration and the RH configuration in the field without the need for any additional parts.

FIG. 12 shows an example of the bottom cable tray 500. In this example, the bottom cable tray 500 has a bottom plate 520 and two vertical plates 510 extending upward from the bottom plate 520. A flange 540 extends from each of the vertical plates 510 and is configured to be connected to the bottom frame 120 of the center rack frame 100 using one or more holes 530.

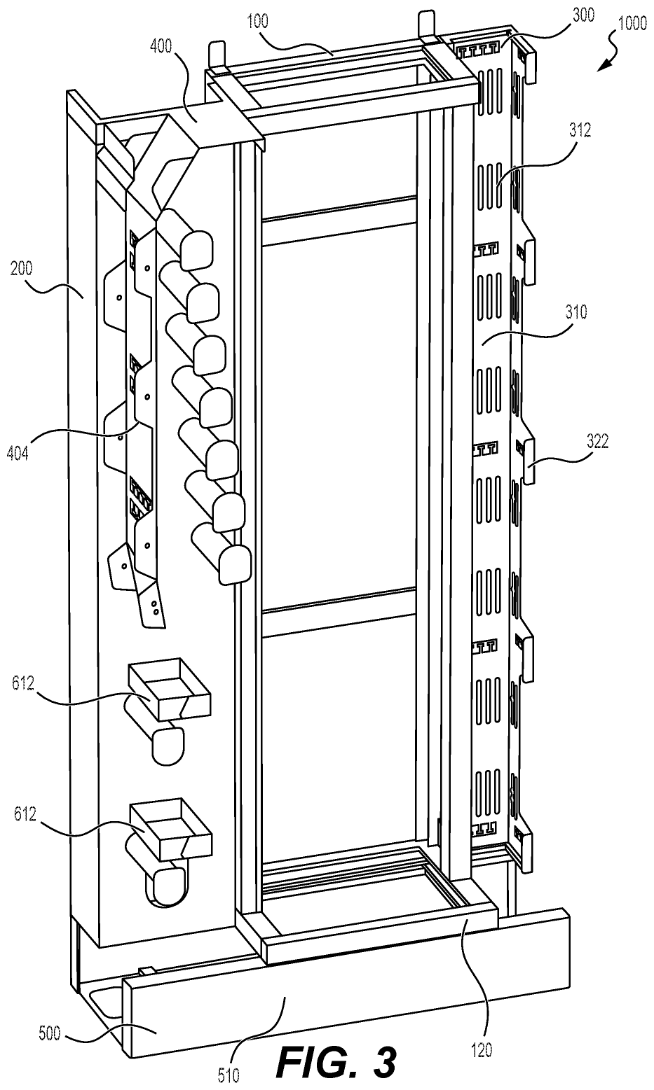

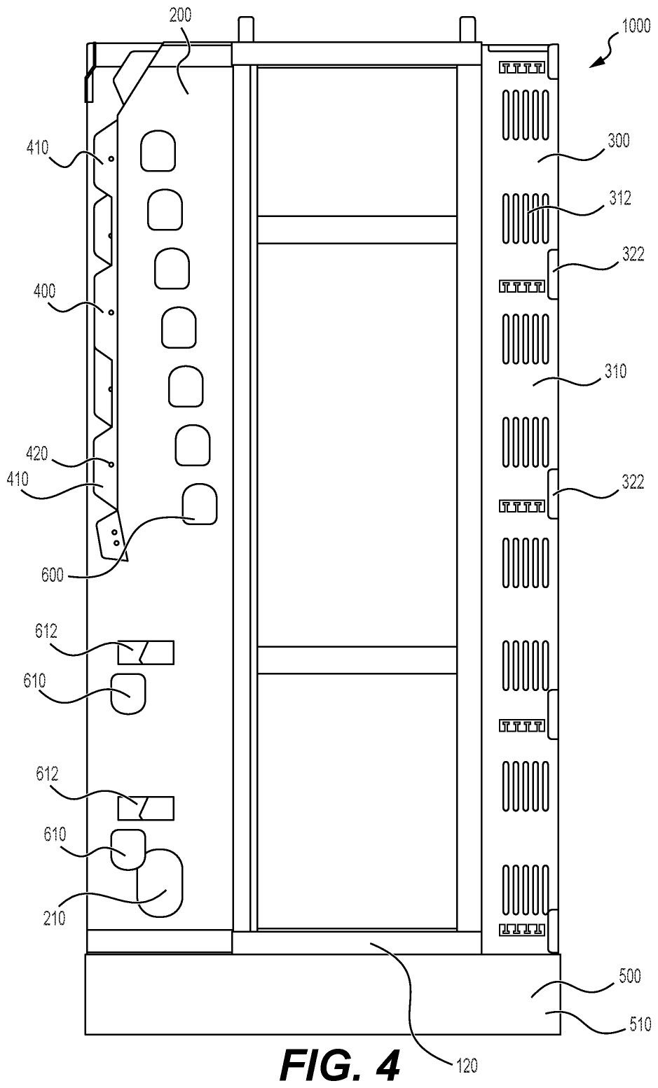

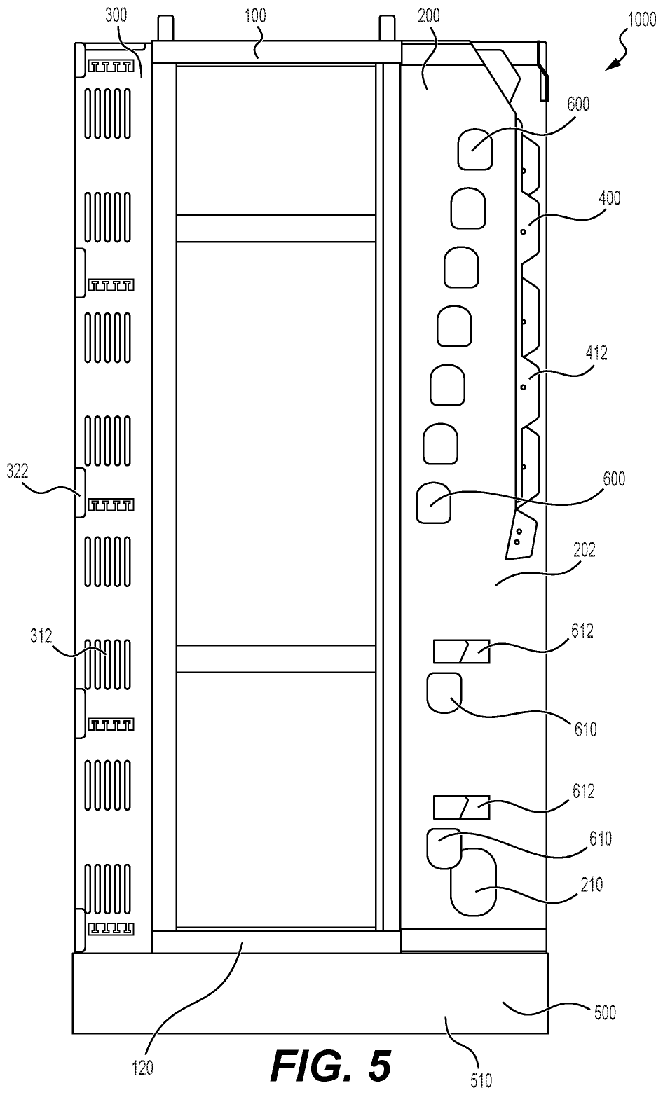

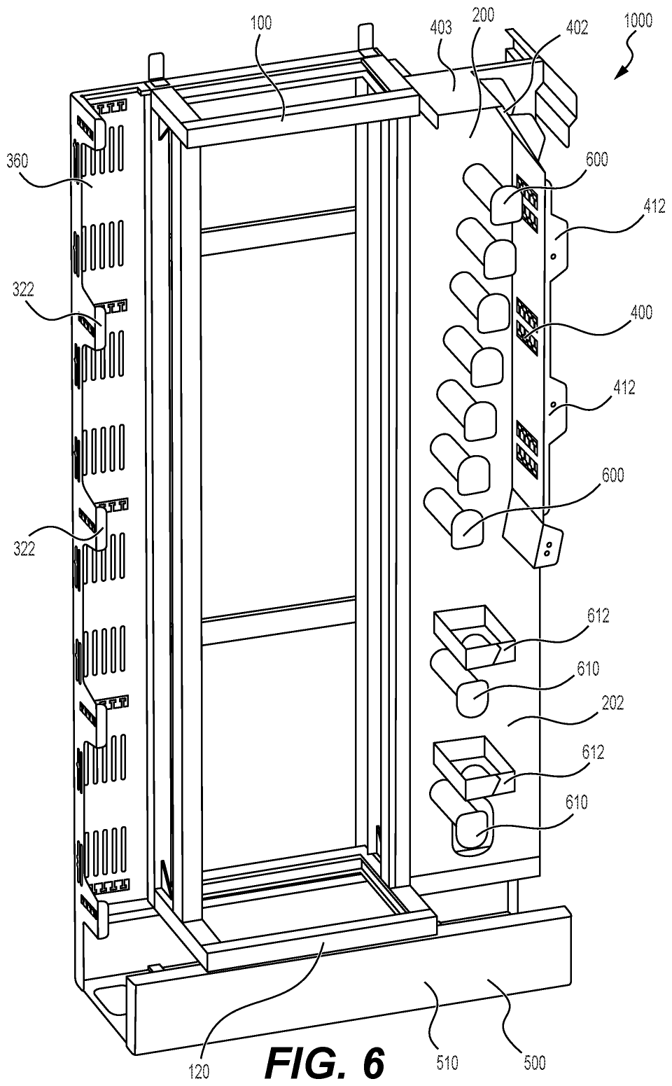

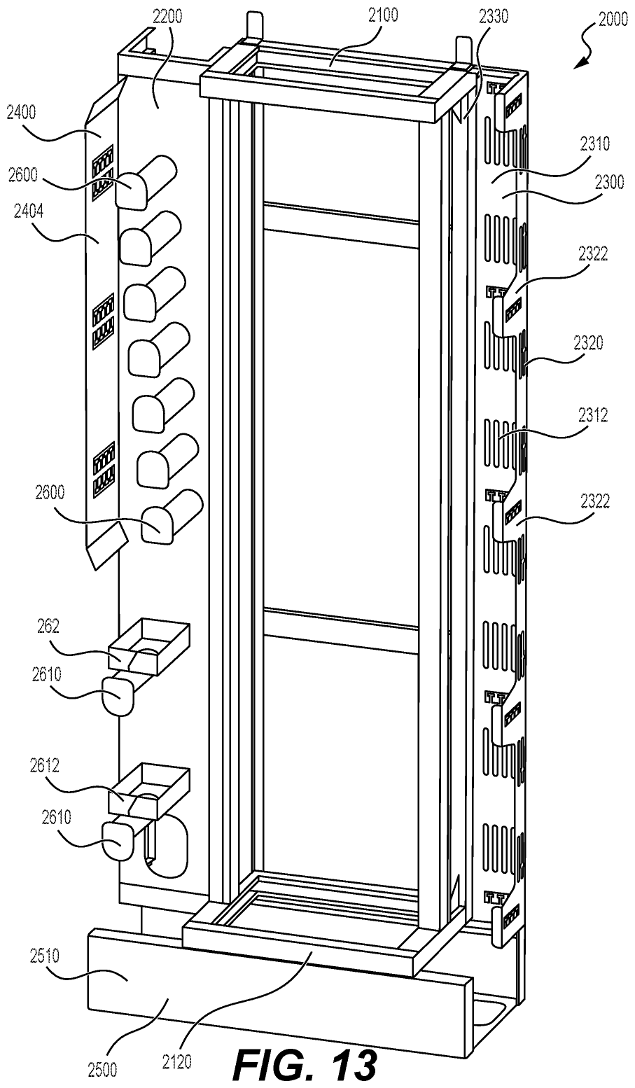

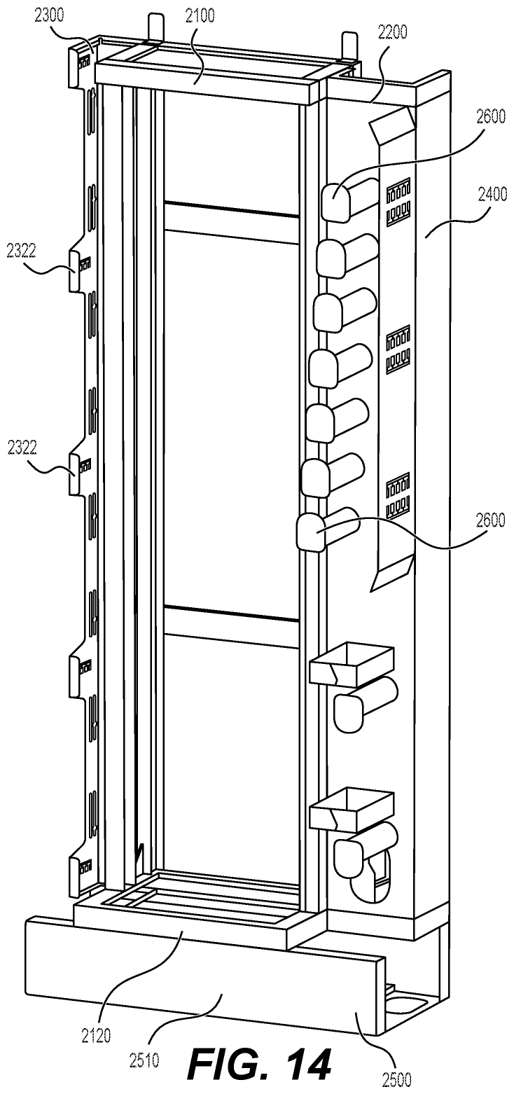

As stated above, FIG. 2 is an example of the rack 1000 in a LH configuration. FIGS. 3 and 4 show other views of the LH rack 1000 shown in FIG. 2. FIGS. 5 and 6 are views of the RH rack 1000 shown in FIG. 1, without the panels 10. FIGS. 1-12 show RH configurations, LH configurations, and components of the rack 1000. These embodiments of the rack 1000 are an example of a rack having a width of 1050 mm. Other embodiments of a rack in accordance with the disclosure have different widths. For example, FIGS. 13 and 14 show a rack 2000 having a width of 900 mm. The embodiments shown in FIGS. 13 and 14 have the same basic structure and many of the same components as the embodiments shown in FIGS. 1-12.

FIG. 13 shows a LH embodiment of a 900 mm wide rack 2000. FIG. 14 shows a RH embodiment of a 900 mm wide rack 2000. In FIG. 13, because it is assembled in a LH configuration, the distribution cable management plate 2200 is attached to the left side of the center rack frame 2100. In this LH configuration, the input cable tray 2300 is attached to the right side of the center rack frame 2100. A drop cable guiding plate 2400 (a different configuration than the input cable tray 300) is attached to the distribution cable management plate 2200. This will be explained in more detail below. The bottom cable tray 2500 is positioned at the bottom of the rack 2000 and is attached to the center rack frame 2100, similarly to the embodiments of FIGS. 1-12. Mandrels 2600, 2610 and shelves 2612 are similar to the mandrels 600, 610 and the shelves 612.

In this example shown in FIG. 13, the input cable tray 2300 has a back plate 2310, an extension 2320 that extends (in this example) at a right angle from the back plate 2310, and a plurality of tabs 2322 that extend from the extension 2320. The input cable tray 2300 also has a flange 2330 that extends (in this example) at a right angle from the back plate 2310. The input cable tray 2300 is symmetrical in the vertical direction. For use in the RH configuration (FIG. 14), the flange 2330 is attached by, for example, screws to the left side of the center rack frame 2100. For use in the LH configuration (FIG. 13), the flange 2330 is attached by, for example, screws to the right side of the center rack frame 2100. In this example, a plurality of slots 2312 are provided in the back plate 2310. The slots 2312 can be used to secure cables to the back plate 2310 using, for example, cable ties.

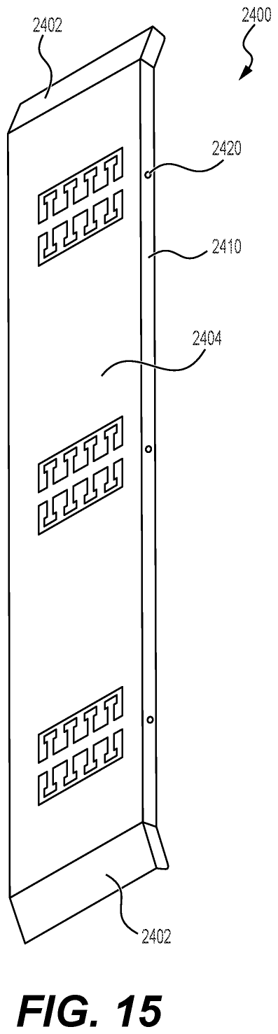

FIG. 15 shows an example of the drop cable guiding plate 2400 used in the embodiments shown in FIGS. 13 and 14. Due to the narrower width of the 900 mm embodiments, the drop cable guiding plate 2400 is smaller than the drop cable guiding plate 400 used in the embodiments shown in FIGS. 1-12. The drop cable guiding plate 2400 has a has a main section 2404, and two angled sections 2402 that extend from the main section 2404, that are configured to guide cables positioned in the distribution cable management plate 2200. The drop cable guiding plate 2400 can be provided with additional sections configured to guide cables positioned in the distribution cable management plate 2200. In this example, the drop cable guiding plate 2400 has a flange 2410 extending from each side. The flanges 2410 are configured to be used to attach the drop cable guiding plate 2400 to the distribution cable management plate 2200 in both the RH configuration (FIG. 14), and the LH configuration (FIG. 13). Each of the flanges 2410 has one or more holes 2420 configured to be used to attach the drop cable guiding plate 2400 to the distribution cable management plate 2200. FIG. 20 shows an alternate example of a drop cable guiding plate 5400 that is configured to be used in the embodiments shown in FIGS. 13 and 14. The drop cable guiding plate 5400 has a has a main section 5404, and two angled sections 5402 that extend from the main section 5404, that are configured to guide cables positioned in the distribution cable management plate 2200.

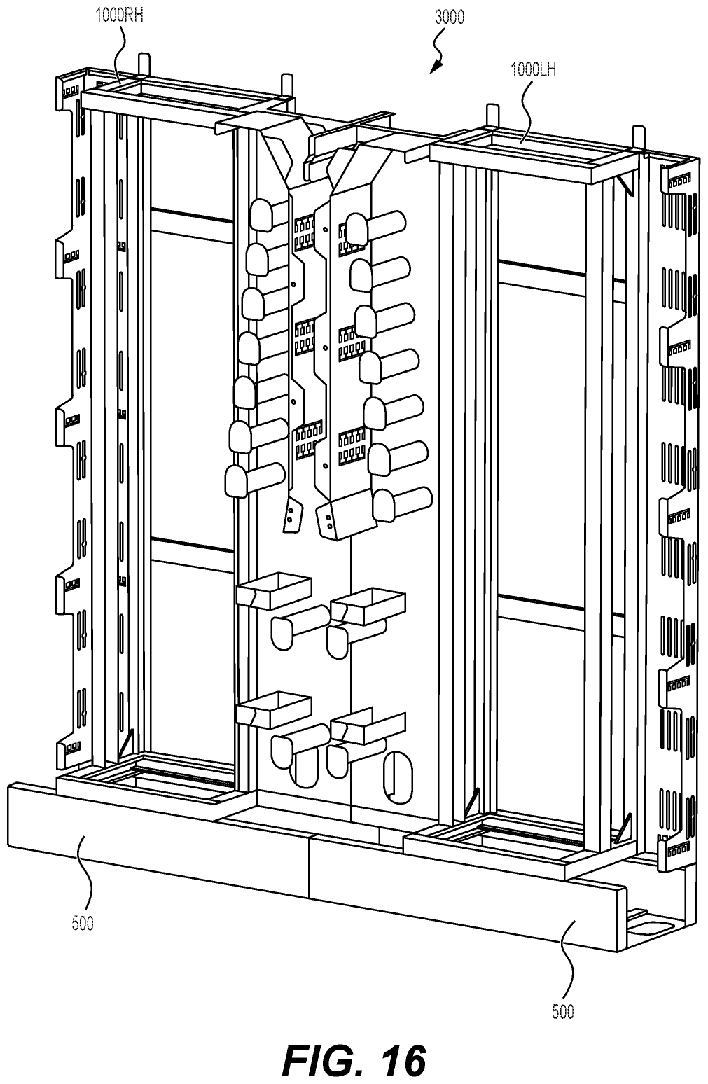

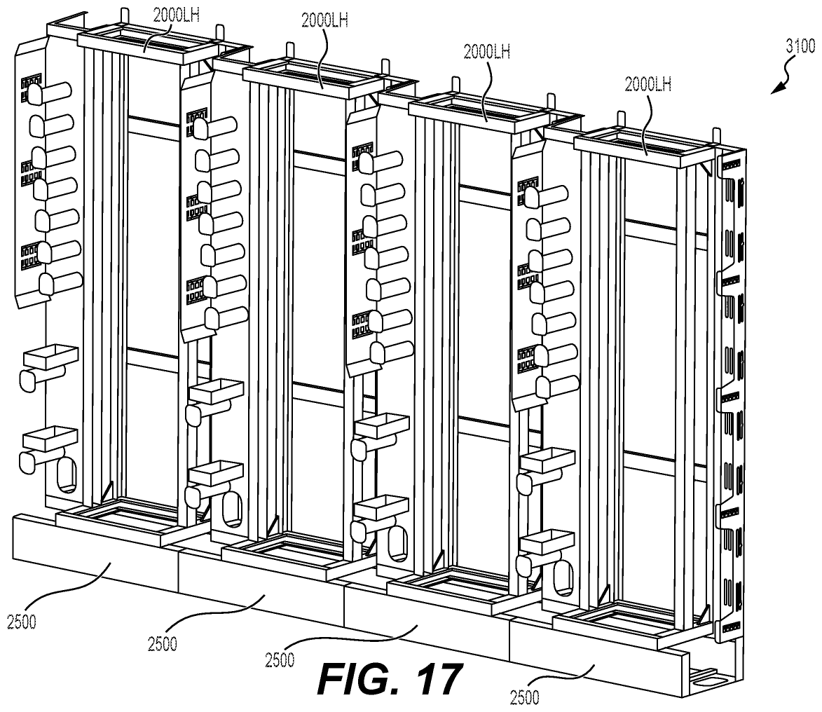

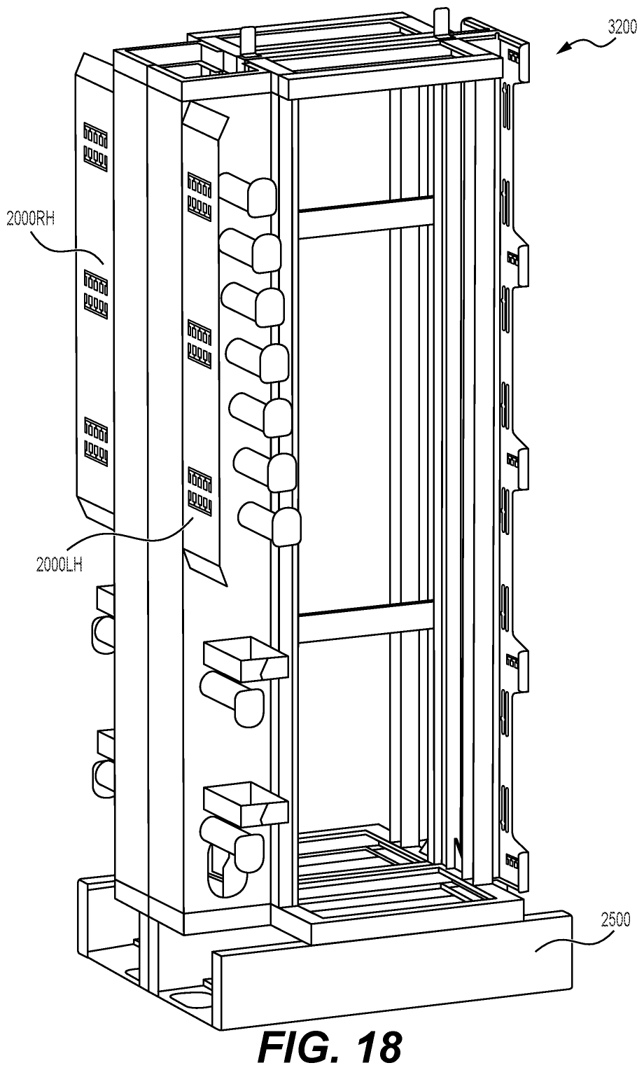

FIGS. 16-18 show non-exclusive examples of combinations of RH and LH configurations of the rack 1000 and the rack 2000. FIG. 16 shows a side-by-side combination 3000 of a RH configuration 1000RH of the rack 1000 and a LH configuration 100LH of the rack 1000. In this example, the two bottom cable trays 500 are attached to each other using screws or other fasteners. FIG. 17 shows a series combination 3100 of four LH configurations 2000LH of the rack 2000. In this example, the four bottom cable trays 2500 are attached to one another other using screws or other fasteners. FIG. 18 shows a back-to-back combination 3200 of one of the rack 2000LH and one of the rack 2000RH. In this example, the two bottom cable trays 2500 are attached to one another other using screws or other fasteners. FIGS. 16-18 show only three examples of possible combinations of the racks 1000, 1000LH, 1000RH, 2000, 2000LH, and 2000RH. Other combinations of any of the racks in accordance with the disclosure can be formed.

A non-exclusive list of advantages of embodiments of the disclosure includes: the cable management system can be configured in LH and RH configurations with the same parts; the parts are designed in such a way that they can be used as a LH assembly and a RH assembly; the number of parts and inventory are reduced; the racks can be connected in different combinations based on a particular requirement; the cable management system can have entry and exit from the top and the bottom on both sides; the bottom cable tray allows cables to transfer from one rack to an adjacent rack; and special mandrel positions are given to manage and identify cables from each of the panels in the rack.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable panel rack comprising:
a center rack frame portion;
a distribution cable management portion configured to be attached to the center rack frame portion;
an input cable portion configured to be attached to the center rack frame portion;
a drop cable guiding portion configured to be attached to the distribution cable management portion;
a bottom cable portion configured to be attached to the center rack frame portion;
wherein the center rack frame portion is structurally configured to receive a plurality of cable panels;
wherein the distribution cable management portion is configured to be alternatively attached to a first side of the center rack frame portion and a second side of the center rack frame portion;
wherein the input cable portion is configured to be alternatively attached to the first side of the center rack frame portion and the second side of the center rack frame portion;
wherein the drop cable guiding portion is configured to be attached to the distribution cable management portion in either a first drop cable guiding portion position or a second drop cable guiding portion position based on a position of the distribution cable management portion;
wherein the center rack frame portion is configured to be attached at a first portion of the bottom cable portion when the distribution cable management portion is attached to the first side of the center rack frame portion;
wherein the center rack frame portion is configured to be attached at a second portion of the bottom cable portion when the distribution cable management portion is attached to the second side of the center rack frame portion; and
wherein the cable panel rack is configured to be arranged as either a left-hand rack with the center rack frame portion attached at the first portion or a right-hand rack with the center rack frame portion attached at the second portion, so as to permit a user to select and/or change a configuration of the cable panel rack at an installation location without needing additional components and without disconnecting cables from the cable panels in the center rack frame portion.

2. The cable panel rack of claim 1, wherein the first side of the center rack frame portion is opposite to the second side of the center rack frame portion.

3. The cable panel rack of claim 1, wherein the distribution cable management portion comprises a first set of holes and a second set of holes.

4. The cable panel rack of claim 3, wherein the drop cable guiding portion is configured to be alternatively attached to the distribution cable management portion in either the first set of holes or the second set of holes.

5. The cable panel rack of claim 4, wherein the center rack frame portion attaches to the bottom cable portion in the first position when the drop cable guiding portion is attached to the distribution cable management portion in the first set of holes.

6. The cable panel rack of claim 5, wherein the center rack frame portion attaches to the bottom cable portion in the second position when the drop cable guiding portion is attached to the distribution cable management portion in the second set of holes.

7. The cable panel rack of claim 1, wherein the cable panel rack further comprises a cable routing portion configured to be attached to the distribution cable management portion.

8. The cable panel rack of claim 7, wherein the distribution cable management portion is configured to have the cable routing portion alternatively attached to the distribution cable management portion in a plurality of locations on the distribution cable management portion.

9. A cable panel rack comprising:
a center rack frame portion structurally configured to receive a plurality of cable panels;
a distribution cable management portion configured to be attached to the center rack frame portion;
an input cable portion configured to be attached to the center rack frame portion;
a bottom cable portion configured to be attached to the center rack frame portion;
wherein the distribution cable management portion is configured to be alternatively attached to a first side of the center rack frame portion and a second side of the center rack frame portion;
wherein the input cable portion is configured to be alternatively attached to the first side of the center rack frame portion and the second side of the center rack frame portion;
wherein the center rack frame portion is configured to be attached at a first portion of the bottom cable portion when the distribution cable management portion is attached to the first side of the center rack frame portion;
wherein the center rack frame portion is configured to be attached at a second portion of the bottom cable portion when the distribution cable management portion is attached to the second side of the center rack frame portion; and
wherein the cable panel rack is configured to be arranged with either the center rack frame portion attached at the first portion or with the center rack frame portion attached at the second portion, so as to permit a user to select and/or change a configuration of the cable panel rack at an installation location without disconnecting cables from the cable panels in the center rack frame portion.

10. The cable panel rack of claim 9, wherein the cable panel rack further comprises a drop cable guiding portion configured to be attached to the distribution cable management portion.

11. The cable panel rack of claim 10, wherein the drop cable guiding portion is configured to be attached to the distribution cable management portion in either a first drop cable guiding portion position or a second drop cable guiding portion position based on a position of the distribution cable management portion relative to the center rack frame portion.

12. The cable panel rack of claim 10, wherein the distribution cable management portion comprises a first set of holes and a second set of holes.

13. The cable panel rack of claim 12, wherein the drop cable guiding portion is configured to be alternatively attached to the distribution cable management portion in either the first set of holes or the second set of holes.

14. The cable panel rack of claim 9, wherein the first side of the center rack frame portion is opposite to the second side of the center rack frame portion.

15. The cable panel rack of claim 9, wherein the cable panel rack further comprises a cable routing portion configured to be attached to the distribution cable management portion.

16. The cable panel rack of claim 15, wherein the distribution cable management portion is configured to have the cable routing portion mounted to the distribution cable management portion in a plurality of locations on the distribution cable management portion.

17. The cable panel rack of claim 9, wherein the cable panel rack is configured to be arranged with either the center rack frame portion attached at the first portion or with the center rack frame portion attached at the second portion, so as to permit a user to select and/or change a configuration of the cable panel rack at an installation location without needing additional components.

18. A cable panel rack comprising:
a center frame portion structurally configured to receive a plurality of cable panels;
a distribution cable management portion configured to be attached to the center frame portion;
a bottom cable portion configured to be attached to the center frame portion;
wherein the distribution cable management portion is configured to be alternatively attached to a first side of the center frame portion and a second side of the center frame portion;
wherein the center frame portion is configured to be attached at a first portion of the bottom cable portion when the distribution cable management portion is attached to the first side of the center frame portion;
wherein the center frame portion is configured to be attached at a second portion of the bottom cable portion when the distribution cable management portion is attached to the second side of the center frame portion; and
wherein the cable panel rack is configured to be arranged with either the center frame portion attached at the first portion or with the center frame portion attached at the second portion, so as to permit a user to select and/or change a configuration of the cable panel rack at an installation location without disconnecting cables from the cable panels in the center rack frame portion.

19. The cable panel rack of claim 18, wherein the cable panel rack further comprise an input cable portion configured to be attached to the center frame portion.

20. The cable panel rack of claim 19, wherein the input cable portion is configured to be alternatively attached to the first side of the center frame portion and the second side of the center frame portion.

21. The cable panel rack of claim 18, wherein the cable panel rack further comprises a drop cable guiding portion configured to be attached to the distribution cable management portion in either a first drop cable guiding portion position or a second drop cable guiding portion position based on a position of the distribution cable management portion relative to the center frame portion.

22. The cable panel rack of claim 21, wherein the distribution cable management portion comprises a first set of holes and a second set of holes, and the drop cable guiding portion is configured to be alternatively attached to the distribution cable management portion in either the first set of holes or the second set of holes.

23. The cable panel rack of claim 18, wherein the first side of the center frame portion is opposite to the second side of the center frame portion.

24. The cable panel rack of claim 18, wherein the cable panel rack further comprises a cable routing portion configured to be attached to the distribution cable management portion, the distribution cable management portion is configured to have the cable routing portion mounted to the distribution cable management portion in a plurality of locations on the distribution cable management portion.

25. The cable panel rack of claim 18, wherein the cable panel rack is configured to be arranged with either the center frame portion attached at the first portion or with the center frame portion attached at the second portion, so as to permit a user to select and/or change a configuration of the cable panel rack at an installation location without needing additional components.
